(19) United States
(12) Patent Application Publication
(10) Pub. No.: US 2019/0077933 A1
(43) Pub. Date: Mar. 14, 2019

(54) PROCESS FOR PREPARING THREE DIMENSIONAL POROUS SCAFFOLD AND THE THREE DIMENSIONAL POROUS SCAFFOLD FORMED THEREOF

(71) Applicant: Indian Institute of Technology Delhi, New Delhi (IN)

(72) Inventors: Rajiv Kumar Srivastava, New Delhi (IN); Bhanu Nandan, New Delhi (IN); Anilkumar Lalchand Yadav, New Delhi (IN); Jit Pal, New Delhi (IN)

(21) Appl. No.: 15/948,592

(22) Filed: Apr. 9, 2018

(30) Foreign Application Priority Data
Sep. 8, 2017 (IN) 201711031869

(51) Int. Cl. C08J 9/14

(52) U.S. Cl. CPC C08J 9/141; C08J 2201/028; C08J 2367/04; C08J 2205/05; C08J 2205/044; C08J 2203/14

(57) ABSTRACT

The present invention discloses a single-step process for the formation of a three dimensional porous scaffold,the process comprising of carrying out ring opening polymerization of a monomer under high internal phase emulsion mode in the presence of at least one catalyst selected from methanesulfonic acid and stannous octoate to form a three dimensional porous scaffold. Further, the present invention discloses a three dimensional porous scaffold comprising of a polymer, to form a three dimensional porous scaffold having a pore size in the range of 0.1-30 micrometer and a porosity in the range of 75%-95%.

### FIELD OF THE INVENTION

The present invention discloses a three dimensional porous scaffold,a single-step process for the formation of the three dimensional porous scaffold

### BACKGROUND OF THE INVENTION

Polymeric porous scaffolds are prepared using a number of techniques namely particulate leaching, phase separation, supercritical fluids, gas blowing, self-assembly, electrospinning, stereolithography, 3D printing and emulsion templating. Problems associated with such methods exceptemulsion templating are that they are multi-step processes and that they involve dissolution of preformed polymer into organic solvent or melting to develop the scaffold.

Emulsion templating, is a single step process for the formation of a porous scaffold but said emulsion templating in the form of high internal phase emulsions (HIPE) has been developed only for vinylic monomers that is monomers bearing a carbon-carbon double bond e.g. styrene,methyl methacrylate, in which polymerization is conducted using free radical polymerization methodology. The generation of in-situ porosity is achieved through the polymerization of continuous phase of HIPE via free radical polymerization mechanism using photo or thermal initiator or using UV-curable monomer. However, emulsion templating has not been carried out for ring-opening polymerization of lactones as it is not only difficult to stabilize a high internal phase emulsion of lactones but there is also deactivation of the catalyst.

Further, polymerization of cyclic monomers including lactone(s) is carried out via ring-opening polymerization in bulk or solution mode and the monomer(s), catalysts involved in the process are highly sensitive to moisture and air. Hence, said polymerization is carried out in an inert atmosphere and not in an open atmosphere as the catalysts tend to deactivatein the presence of air or moisture.

Therefore, there exists a need for the formation of a three dimensional porous scaffold based on aliphatic polyester, via in-situ generation of porosity wherein the ring opening polymerization of a monomer's carried out in a single step and in a high internal phase emulsion mode using such sensitive catalysts in a non-inert atmosphere.

### SUMMARY OF THE INVENTION

Accordingly, an embodiment of the present invention discloses a process for preparing a three dimensional porous scaffold, the process comprising carrying out ring opening polymerization of a monomer in a high internal phase emulsion mode in the presence of at least one catalyst selected from methanesulfonic acid and stannous octaoate to form a three dimensional porous scaffold.

Another embodiment of the present invention discloses a three dimensional porous scaffold comprising a polymer, to form a three dimensional porous scaffold having a pore size in the range of 0.1-30 micrometer and a porosity in the range of 75%-95%.

### BRIEF DESCRIPTION OF THE DRAWINGS

FIG. 1: Stable oil-in-oil High Internal Phase Emulsion (HIPE) formed using lactone monomer (CL) as the continuous phase and another hydrophobic compound (e.g. hexadecane) as the dispersed phase (a) stable for more than 48 hours (b) corresponding optical microscope image.

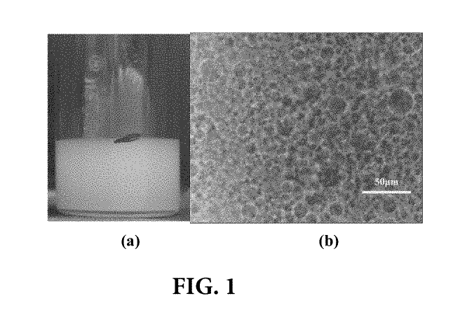

FIG. 2: ¹H-NMR spectrum indicating complete monomer conversion during HIPE-ROP of CL (disappearance of peak at 4.2 ppm). Peak at 4.0 ppm originated form polymer which also vanished after some time as insoluble cross-linked polymer started to form.

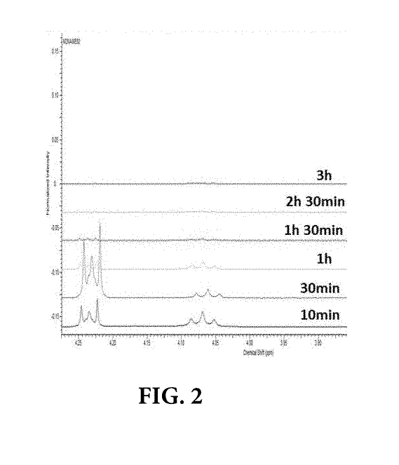

FIG. 3: Scanning Electron Microscope(SEM) images of uncross-linked porous scaffolds formed via HIPE-Ring Opening Polymerization of ε-caprolactone monomer(CL).

FIG. 4: Scanning Electron Microscope (SEM) images of cross-linked porous scaffold formed via HIPE-ROP of ε-caprolactone (CL)with a bifunctional monomer

FIG. 5: Swollen cross-linked scaffold (in chloroform) (a) original sample (b) optical microscope image

### DETAILED DESCRIPTION OF THE INVENTION

The present invention discloses a process for the formation of a three dimensional porous scaffold via in-situ generation of porosity during ring-opening polymerization (ROP) of a cyclic monomer carried out in a high internal phase emulsion (HIPE) mode using highly sensitive organo-metallic catalysts. In the present invention, in a single-step process,a porous construct of desired intricate three dimensional (3D) shape made of an aliphatic polyester is thus obtained as the final product.

An embodiment of the present invention discloses a process for preparing a three dimensional porous scaffold, the process comprising carrying out ring opening polymerization of a monomer in a high internal phase emulsion mode in the presence of at least one catalyst selected from methanesulfonic acid and stannous octaoate to form a three dimensional porous scaffold.

In said embodiment ring opening polymerization is carried out in an oil in oil high internal phase emulsion(HIPE) mode. Said HIPE is prepared by dispersing drop-wise a hydrophobic compound (the dispersed phase) under high speed stirring in a continuous phase which is also known as the oil phase comprised of a monomer and an emulsifier. The volume fraction of the dispersed phase is kept at ≥0.74. Stabilizers are also added to the continuous phase to enhance the stability of the HIPE during polymerization. Monomer soluble catalysts solubilized in the monomer are added to catalyze high internal phase ring opening polymerization (HIPE -ROP)which is carried out in an open environment (without any inert atmosphere) and complete monomer conversion is achieved. Polymerization of the monomer in the formed HIPE is carried out by heating at a temperature in the range of 40° C. to 180° C. for 4-8 hours. In-situ formation of pores is achieved during polymerization resulting in the complete monomer conversion and formation of the three dimensional porous scaffold having interconnected pores and desired porosity. NMR spectroscopy confirms such complete conversion. After polymerization, the porous scaffold is washed with hexane and methanol multiple times preferably 5 times to remove the dispersed phase and any unreacted ingredient and then, dried and stored under vacuum.

The monomer used in the process is a hydrophilic or hydrophobic monomer. Said monomer is a cyclic monomer selected from a group comprising of a cyclic structure having 4-20 atoms preferably selected from lactones, lactides and carbonates. Small to large ring sized lactones are used. Preferably the monomer is ε-caprolactone. Further, for a cross linking reaction, a bifunctional monomer preferably bis (ε-caprolactone-4-yl) is added to the continuous phase.

Organometallic catalysts such as methanesulfonic acid (MSA) when used individually is present in an amount of 0.01-10 weight percent with respect to the monomer, stannous octoate is present in an amount of 0.01-10 weight percent with respect to the monomer.

A combination of the two monomer soluble catalysts namely stannous octoate and methane sulfonic acid catalyzes a cross linking reaction in the formation of a cross linked three dimensional porous scaffold via High Internal Phase Emulsion Ring Opening Polymerization (HIPE-ROP) of a monomer. In said combination of catalysts, stannous octoate is present in an amount of 0.01-10 weight percent of the monomer and methane sulfonic acid is present in an amount of 0.01-10 weight percent with respect to the monomer. In the present invention, when the catalysts are used in a pair one catalyzes homo polymerization namely methane sulfonic acid and the other namely stannous octoate catalyzes cross-linking reaction. Homopolymerization is carried out at 40° C. for 6 hours to achieve complete monomer conversion. Further, for cross-linking the reactants are subjected to 40° C. for the first 4 hours followed by heating at 180° C. for additional 2 hours.

The hydrophobic compound is selected from a group comprising of olefins having C₆-C₁₆carbon atoms,preferably the hydrophobic compound is hexadecane.

Emulsifiers is an amphiphilic molecule comprised of block copolymers of ethylene glycol and propylene glycol. Preferably the emulsifier is Pluronic F-127(of Sigma Aldrich, a tri-block copolymer of poly(ethylene oxide)-b-(propylene oxide)-b-(ethylene oxide) (CAS no. 9003-11-6)).Stabilizers such as preformed poly (ε-caprolactone) (PCL), poly (L-lactide) (PLLA) solvent such as dimethyl sulfoxide (DMSO) are used.

Purity of the chemicals including monomer and catalyst is selected over a wide range to suit the applicability of the process at commercial level. Preferably, monomers and catalyst having purity of 90-100% is used in the present invention

An advantage of the process disclosed in the present invention is that carrying out Ring Opening Polymerization of a monomer using sensitive organo-metallic catalyst in a high internal phase emulsion (HIPE) mode does not affect the activity of the monomer or the activity of the catalyst.

A preferable embodiment of the present invention, discloses a process for the formation of a cross linked three dimensional porous scaffold,wherein a cross linking bifunctional monomer is used to obtain a cross linked polymer. In such a case a bifunctional monomer at a theoretical cross-link density of 5 to 50% and an emulsifier is added to the continuous phase.

In said preferable embodiment a high internal phase emulsion (HIPE) is prepared by dispersing a hydrophobic compound selected from a group comprising of olefins having C₆-C₁₆ carbon atoms in a continuous phase comprising of a cyclic monomer such as ε-caprolactone, a crosslinking monomer such as a bifunctional monomer preferably bis(ε-caprolactone-4-yl) and an emulsifier. The volume fraction of the dispersed phase was kept at ≥0.74. Stabilizers are added to the continuous phase to enhance stability of HIPE during polymerization. The reactants were subjected to 40° C. for first 4 hours followed by heating at 180° C. for additional 2 hours. Monomer soluble catalysts are used in a combination of methane sulfonic acid and stannous octoate to catalyze high internal phase ring opening polymerization (HIPE -ROP) as well as cross linking which is carried out in an open environment (without any inert atmosphere) in a single reactor. Methanesulfonic acid is present in an amount of 0.01-10 weight percent with respect to the monomer and the stannous octoate is present in an amount of 0.01-10 weight percent with respect to the monomer. Using said catalysts in combination provides flexibility in conducting polymerization at the beginning at a relatively lower temperature such as 40° C. It is towards the later part of polymerization that the temperature is increased to more than 100° C. whereas if only a single catalyst such stannous octoate is used then at the beginning of the reaction higher temperatures such as 90° C. or above is required. In-situ formation of pores is achieved during polymerization resulting in the complete monomer conversion and formation of the cross linked three dimensional porous scaffolds based on homo and cross linked aliphatic polyester in a single step. After polymerization the porous scaffold is washed with hexane and methanol 5 times, dried and stored under vacuum

Thus, in the present invention, cross-linking induced during polymerization with the help of a bifunctional monomer resulted in formation of a network macromolecular structure of a very high swelling index. The network of macromolecular structure of the final cross-linked aliphatic polyester based porous scaffold obtained is of a very high swelling index ranging from 500-2000%. Thus, the scaffold has high potential to be used in tissue engineering, selective adsorption and oil-water separation.

Thus, the process of the present invention has the following advantages:
Polymerization of cyclic monomers e.g. lactones, lactides and carbonates under HIPE mode.
It is a single-step process to obtain three dimensionsal (3D) porous scaffold based on monomers of aliphatic polyester(s) and/or aliphatic carbonate(s) with/without cross-linking.
A 3D porous scaffold of intricate 3D shape is obtained which is suitable for variety of applications, such as the final cross linked aliphatic polyester based porous scaffold which showed a swelling capacity of 500-2000% scaffold has a high potential to be usedin tissue engineering, selective adsorption and oil-water separation.
A control on the pore size and interconnectedness is obtained by the process of the present invention via tailoring the HIPE formulation and polymerization conditions such as more the dispersed phase, a larger pore size, more distribution and more interconnectivity is obtained. Further, in the process disclosed in the present invention, 100% monomer conversion is obtained when high internal phase ring opening polymerization (HIPE-ROP) of caprolactone was carried out at 40° C. using methanesulfonic acid(MSA) as catalyst. 100% monomer conversion with formation of a cross-linked polymeric structure, swell index ˜1800% and gel content ˜70% isobtained when high internal phase ring opening polymerization (HIPE-ROP) is carried out using both the catalysts i.e. methanesulfonic acid(MSA) and stannous octoate and the polymerization was carried out with increase in temperature from 40° C. to 180° C.

Another embodiment of the present invention discloses a three dimensional porous scaffold comprising of a polymer to form a three dimensional porous scaffold having a pore size in the range of 0.1-30 micrometer and a porosity in the range of 75%-95%.

In said embodiment, the polymer is optionally in cross linked form which results in a three dimensional cross linked porous scaffold. The swelling capacity of such a cross linked scaffold is5 to 20 times of its original volume

The polymeric scaffold thus obtained is characterized by spectroscopy, optical and electron microscopy.

### EXAMPLES

The following examples illustrate the process to prepare a three dimensional porous scaffold, but are not limiting thereof.
1. 2 g, 0.0175 moles ε-caprolactone (CL) monomer was mixed with 0.6 g, 30 weight percent of CL surfactant Pluronic-127 and, 0.0336 g, 0.00035 molesmethanesulphonic acid (MSA), keeping theoretical degree of polymerization=50) to form the continuous oil phase of the emulsion. Hexadecane (4.64 g, 6 mL, 0.020 mol, to keep volume fraction of dispersed phase=0.75), the dispersed phase, was added to the continuous phase under constant magnetic stirring to form the high internal phase emulsion (HIPE). The HIPE thus formed was heated at 40° C. for 6 hours to generate uncross-linked poly(ε-caprolactone) (PCL) based porous solid scaffold. The scaffold was washed with n-hexane and methanol (to remove hexadecane and any unreacted ingredient) and dried under vacuum.
2. 2 g, 0.0175 moles ε-caprolactone (CL) monomer was mixed with0.6 g, 30 weight percent of CL, surfactant Pluronic-127, 0.142 g, 0.00035 moles stannous octate (keeping theoretical degree of polymerization=50) and 0.497 g, 0.0022 moles bis-(ε-caprolactone-4-yl) cross-linking monomer (at theoretical cross-linking density=20%, according to equation 1) to form the continuous oil phase of the emulsion. 4.64 g, 6 mL Hexadecane (volume fraction of dispersed phase=0.75), the dispersed phase, was added to continuous phase under constant magnetic stirring to form the high internal phase emulsion (HIPE). The HIPE thus formed was heated at 120° C. for 6 hours to generate cross-linked poly(ε-caprolactone) (PCL) based porous solid scaffold. The scaffold was washed with n-hexane and methanol (to remove hexadecane and any unreacted ingredient) and dried under vacuum.
3. 2 g, 0.0175 moles ε-caprolactone (CL) monomer was mixed with 0.6 g, 30 weight percent of CL surfactant Pluronic-127 , 0.071 g, 0.000175 moles stannous octate (keeping overall theoretical degree of polymerization=50), 0.0168 g, 0.000175 mol, methane sulfonic acid (MSA), (keeping overall theoretical degree of polymerization=50) and 0.497 g, 0.0022 moles of cross-linking monomer bis-(ε-caprolactone-4-yl) (BCY) (at theoretical cross-linking density=20%, according to equation 1) to form the continuous oil phase of the emulsion. 4.64 g, 6 mL Hexadecane (volume fraction of dispersed phase=0.75), the dispersed phase, was added to continuous phase under constant magnetic stirring to form the high internal phase emulsion (HIPE). The HIPE thus formed was heated at 40° C. for 6 hours and 180° C. for 2 hours to generate cross-linked poly(ε-caprolactone) (PCL) based porous solid scaffold. The scaffold was washed with n-hexane and methanol (to remove hexadecane and any unreacted ingredient) and dried under vacuum.

$$Theoretical cross \text{-} linked density ( \% ) = \frac{2 a}{( 2 a + b )} \times 100 \qquad Equation 1$$

where, a and b are the moles of BCY and CL, respectively

### Experimental Data

Nuclear Magnetic Resonance (NMR) Spectroscopy

The monomer conversion is determined by ¹H NMR. A Bruker-400 NMR instrument operating at 400 MHz was used for this purpose. CDCl₃ is used as solvent as well as internal standard (δ=7.26 ppm). Intensity of peaks originating from protons of monomerε-caprolactone (CL) are compared with those of polymer (PCL) to calculate the monomer conversion. Precisely, peak intensity of oxy-methylene proton from ε-caprolactone (CL) (appearing at ˜4.2 ppm) is compared to that of oxy-methylene proton from poly(ε-caprolactone) (PCL) (appearing at ˜4.0 ppm). As the polymerization progresses, peak intensity of protons from ε-caprolactone (CL) monomer decreases as for those from poly(ε-caprolactone) (PCL) increases.

In case of a cross-linked polymer, no peak in NMR confirmed the formation of a cross-linked polymer, as the polymer is insoluble in any solvent including CDCl₃.

Scanning Electron Microscopy (SEM)

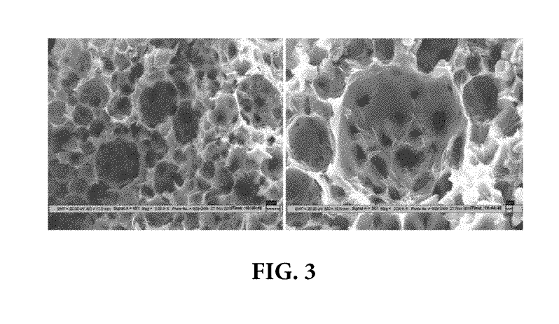

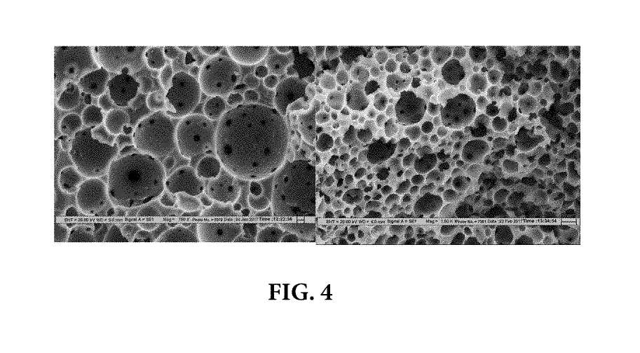

The pore formation, size and interconnectivity in scaffolds is studied from SEM images acquired using a Zeiss Evo 50 Scanning Electron Microscope. The samples are pre-coated with gold before analysis. Pore size from a SEM image is calculated using ImageJ analysis. A reference scale is selected on the ImageJ software and size of the pore is measured on the basis of pixels covered against the reference. Average of 100 measurements are reported to be the size of pores. The pore formation and interconnectedness obtained as a result of the process of the present invention is shown in FIGS. 3, 4.

Optical Microscopy

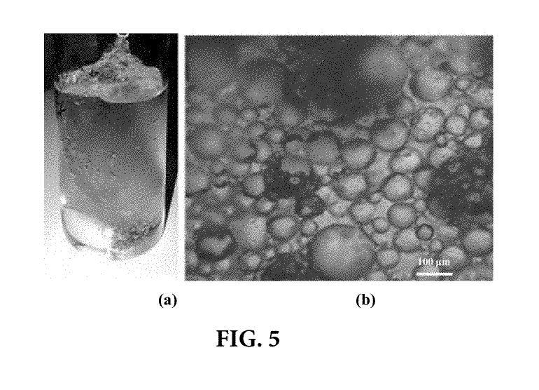

The samples are analyzed for their porosity using a Nikon Eclipse E200 optical microscope under the refractive mode. A microscope image of the polymer was taken with 20× magnification. The optical microscope image of polymer 5 reflected porous structure and interconnected pores. FIG. 5(b) shows the optical microscope image of the swollen cross-linked scaffold.

Swelling Index

The swelling capacity of the scaffold is measured at room temperature in chloroform by using gravimetric technique. A known quantity (˜1 gram) of vacuum dried scaffold is weighed (Mo) and placed in vial to which chloroform (˜30 ml) is added. The vial is left to stand for 3 days at room temperature. Chloroform is then decanted to remove the soluble fraction of polymer from scaffold, and the scaffold is weighed again (Ms). Mass of the vacuum dried scaffold (Mo), and after swelling in chloroform(Ms), is measured on an electronic balance. Swell index is determined by the equation 1:

$$Swell Index = \frac{( {M}_{S} - {M}_{O} )}{{M}_{O}} \times 100$$

FIGS. 5(a) and 5(b) show a swollen scaffold and the typical value for swell index obtained is 15 times or 1500%.

The forgoing description of the invention has been set merely to illustrate the invention and is not intended to be limiting. Since, modifications of the disclosed embodiments incorporating the spirit and substance of the invention may occur to a person skilled in the art, the invention should be construed to include everything within the scope of the disclosure.

We claim:

1. A single-step process for preparing a three dimensional porous scaffold, the process comprising:
carrying out ring opening polymerization of a monomer in a high internal phase emulsion mode in the presence of at least one catalyst selected from methanesulfonic acid and stannous octoate to form a three dimensional porous scaffold.

2. The process as claimed in claim 1, wherein the process is carried out optionally with a cross linking monomer.

3. The process as claimed in claim 1, wherein the high internal phase emulsion mode is formed by dispersing a hydrophobic compound in the monomer using an emulsifier.

4. The process, as claimed in claim 1, wherein the methanesulfonic acid is present in an amount of 0.01-10 weight percent with respect to the monomer and the stannous octoate is present in an amount of 0.01-10 weight percent with respect to the monomer.

5. The process as claimed in claim 1, wherein the monomer is a cyclic monomer.

6. The process as claimed in claim 1, wherein the cyclic monomer is selected from a group comprising of a cyclic structure having 4-20 atoms preferably selected from lactone, lactide and carbonate.

7. The process as claimed in claim 1, wherein the monomer is ε-caprolactone.

8. The process as claimed in claim 2, wherein the cross-linking monomer is bis(ε-caprolactone-4-yl).

9. The process as claimed in claim 3, wherein the hydrophobic compound is selected from a group comprising of olefins having C₆-C₁₆carbon atoms.

10. The process as claimed in claim 3, wherein the hydrophobic compound is hexadecane.

11. The process as claimed in claim 1, wherein polymerization of the monomer in high internal phase emulsion mode occurs at a temperature of 40° C. -180° C.

12. The process as claimed in claim 3, wherein the emulsifier is an amphiphilic molecule comprised of block copolymers of ethylene glycol and propylene glycol.

13. The process as claimed in claim 1, wherein the high internal phase emulsion mode is an oil-in-oil emulsion.

14. A three dimensional porous scaffold comprising of:
a polymer to form a three dimensional porous scaffold having a pore size in the range of 0.1-30 micrometer and a porosity in the range of 75-95%.

15. The three dimensional porous scaffold as claimed in claim 14, wherein the polymer is optionally in cross linked form.
